(19) United States
(12) Patent Application Publication
(10) Pub. No.: US 2026/0192393 A1
(43) Pub. Date: Jul. 9, 2026

(54) Method for Producing a Structural Component, and Structural Component

(71) Applicant: Bayerische Motoren Werke Aktiengesellschaft, Muenchen (DE)

(72) Inventors: Stefanus BOSCH, Holzkirchen (DE); Tobias HAUSER, Bubesheim (DE); Falco HOLLMANN, Garching (DE); Johannes PAULI, Muenchen (DE)

(21) Appl. No.: 19/133,307

(22) PCT Filed: Nov. 28, 2023
(86) PCT No.: PCT/EP2023/083367

§ 371 Date: May 28, 2025

(30) Foreign Application Priority Data
Feb. 1, 2023 (DE) 10 2023 102 410.8

(51) Int. Cl. B23K 26/342; B23K 9/04; B23K 101/00

(52) U.S. Cl. CPC B23K 26/342; B23K 9/042; B23K 2101/006

(57) ABSTRACT

A method for producing a structural component for a motor vehicle, includes the following steps: providing a central workpiece with at least one finish-machined region, positioning the central workpiece using the finish-machined region in a predefined position in a manufacturing device for wire-based deposition welding, geometrically extending the central workpiece by a first component section on a first side of the central workpiece and geometrically extending the central workpiece by a second component section on a second side of the central workpiece, the second side being opposite the first side, wherein the geometric extension is carried out by the layer-by-layer application of material via wire-based deposition welding. A structural component produced according to the method is also provided.

### BACKGROUND AND SUMMARY

The invention elates to a method for producing a structural component, and to a structural component.

In motor vehicles, structural components have load-bearing purposes and define the stability and crash safety of the vehicle. Usually, structural components are produced as welded steel constructions made of metal sheets and profiles. Such structural components are frequently too expensive. Furthermore, structural components are known which are produced as composite components using, for example, fiber-reinforced plastics. Such structural components are expensive to produce.

Against this background, the invention addresses the problem of specifying an improved possible way of producing structural components for motor vehicles. In particular, a reduction in weight and cost-effective production are intended to be allowed.

The problem is solved by a method for producing a structural component and by a structural component according to the independent claims. Further advantageous refinements will become apparent from the dependent claims and the following description.

A method for producing a structural component is specified, which comprises the following steps:
providing a central workpiece having at least one finish-machined region,
positioning the central workpiece using the finish-machined region in a predetermined position in a manufacturing device for wire-based build-up welding,
geometrically extending the central workpiece with a first component portion on a first side of the central workpiece, and
geometrically extending the central workpiece with a second component portion on a second side of the central workpiece that is on the opposite side from the first side,

wherein the geometric extension of the central workpiece is effected by the application of material in layers by means of wire-based build-up welding.

The central workpiece is made, for example, from a metal sheet, an (extruded) profile or a cast body. The metal sheet may be preformed, for example, folded, deep-drawn, etc. The central workpiece has at least one finish-machined region. The finish-machined region is in a state in which it is required in the finished structural component. For example, the finish-machined region may be a contact surface which has already been finally surface machined. The central workpiece may be, for example, a semifinished product, such that individual regions are still unmachined, or it may be provided as completely finish-machined component. Preferably, the central workpiece is made of a metal or a metal alloy.

The at least one finish-machined region of the central workpiece is used to position the central workpiece in a manufacturing device for wire-based build-up welding. For example, a handling device, for example, an industrial robot, can grip and clamp the central workpiece in the finish-machined region.

The manufacturing device for wire-based build-up welding is designed to transfer a wire-form material into the molten state and to apply it in layers to the central workpiece. In the process, the molten material is materially bonded to the central workpiece or to the material to which it is applied. In one refinement, it is particularly preferred for the first and second component portions to be produced by means of wire arc additive manufacturing (WAAM) or laser directed energy deposition (laser DED). In WAAM, a metal wire is melted using an electric arc and applied to the component in the desired form in layers for example by means of a multiaxial manipulator. The laser DED method proceeds in a similar way, but the wire is melted by means of laser radiation. Both methods are characterized by very high application rates and high flexibility in terms of the geometries that are able to be applied. A weight reduction can be realized on account of increased degrees of freedom in the production process. In addition, components with very high ductility can be built up with this method when use is made of an appropriate wire material.

As a result of the use of a central workpiece, that proportion of the structural component that is created by additive manufacturing is reduced. This reduces the manufacturing time, and the manufacturing costs can be lowered. In the context of the present invention, it has been recognized that, through the combination of a wire-based additive manufacturing method with a prefabricated central workpiece, the advantages of both methods can be combined optimally. Specifically, this means that the cost advantages of conventional manufacturing methods, for example, casting methods or sheet forming methods, are combined with the advantages of additive manufacturing in terms of high flexibility in component design and the resultant weight reduction, low costs and rapid implementability of component changes. With the claimed hybrid structure of the structural component, the invention diverges from the previously common assumption that structural components should be built up monolithically, at least when the type of material is intended to be unitary.

In one refinement, it is preferred for the central workpiece to have its final geometric intended shape at the start of the method. The final geometric intended shape corresponds to the desired shape in the finished structural component. In particular, the geometric intended shape may define a surface profile (for example a planarity or desired bend of the surface).

Alternatively, provision is made in one refinement for the central workpiece to have, at the start of the method, an initial shape that differs from its final geometric intended shape and has been determined such that the central workpiece is transferred into its final geometric intended shape by the thermal distortion that arises in the method. For example, component distortion that arises during the method can be simulated in advance or be determined by tests. This component distortion is then applied, for example, in a negative direction, to the final geometric intended shape, resulting in an initial shape of the central workpiece. The thermal distortion during the method then ensures that the central workpiece is transferred back into its final geometric intended shape.

The component portion and the second component portion are produced by applying material in layers to the central workpiece. The first and the second component portion have preferably structural purposes in the structural component and may, for example, represent parts of the load path. Provision may be made for the first component portion to be finished first and then for the second component portion to be created. The manufacturing device for wire-based welding may be designed to position the central workpiece in each case such that material can be applied optimally. For example, the handling device may be designed to rotate the central workpiece in order that the material can be applied, for example, in the direction of gravity. In order to minimize component distortion, it is particularly advantageous when a layer of the first component portion and a layer of the second component portion are each created alternately. For example, the central workpiece may be oriented such that a first layer of material is applied to the first side. Subsequently, the central workpiece is rotated through, for example, 180 degrees such that the second side is at the top and a first layer of material is applied there. These steps are repeated, with the result that the first and second component portion grow uniformly into space. Once the first or the second component portion has been completed, the method is continued only on the side of the other component portion in order to also end this component portion. As a result of the alternate application of material layers to mutually opposite sides of the central workpiece, the heat input is improved and (virtually) distortion-free build-up on the central component is possible. This procedure is advantageous when the central workpiece already has its final geometric intended shape at the start of the method.

In order, in a simple manner, to create a possible way of fastening to the vehicle, in one refinement, the central workpiece may, at the start of the method, have fastening points which are required on the finished structural component. These fastening points may be, for example, threads, receiving holes, attachment faces for welding, etc. The fastening points may thus already be manufactured on the central workpiece. Since the central workpiece can be much smaller than the finished structural component, handling is easier and smaller systems can be used. The production of the fastening points is accordingly easier.

For cost-effective production of the structural component, it is particularly advantageous when, to position the central workpiece at the start of the method, fastening points are used that have been formed in the finish-machined region and are required on the finished structural component. For example, the fastening point or a plurality of fastening points, for example an opening, a thread or a through-hole, which is required in the finished structural component, can also be used to fix the handling device thereto. Thus, not only is exact positioning on the handling device ensured but two functions are also combined in one feature.

In one refinement, the central workpiece is made of sheet metal. The sheet metal can, for example, be bent, cut, drilled or processed in some other way. The use of a metal sheet as the central workpiece allows particularly cost-effective production.

Preferably, the central workpiece is a plate-like body. The plate-like body preferably has a thickness that is very much less than the rest of the dimensions of the plate-Attorney like body. For example, the thickness may be in the region of a few millimeters, for example less than 5 mm. The plate-like body may be used as a base plate for building up the first and second component portions on either side. The susceptibility of a plate-like body to thermal distortion can, according to the invention, be compensated in that the first and second component portions are preferably built up alternately. In this regard, it may also be advantageous for any component distortion that arises to already be taken into account in the production of the plate-like body, with the latter being provided with an initial shape that differs from the final geometric intended shape.

In one refinement, the first and/or second component portion has/have a hollow body. This allows a particularly lightweight construction of the structural component. Since the first and the second component portion are built up in two opposite directions starting from the central workpiece, geometric degrees of freedom are possible that, with generative production methods, could otherwise only be built up with complicated and manufacturing time-consuming support structures. For example, the first and the second component portion may have hollow body structures which taper conically from the central workpiece in the direction of their free end.

Furthermore, a structural component is specified having a central workpiece with at least one exposed region, a first component portion which has been manufactured by means of wire-based build-up welding and has been joined to the central workpiece on a first side of the latter, and a second component portion which has been manufactured by means of wire-based build-up welding and has been joined to the central workpiece on a second side of the latter on the opposite from the first side. During the production of the additively manufactured component portions, the exposed region serves to receive and position the central workpiece in the manufacturing device and accordingly remains free of an additively manufactured additional structure. Preferably, the structural component has been formed using the above-described method and, as such, achieves the same technical effects and advantages as are described for the method.

The structural component is preferably a structural component for a motor vehicle, and, for example, a body component, for example a tunnel reinforcement for a vehicle body.

Further advantages, features and details of the invention will become apparent from the following description, in which exemplary embodiments of the invention are described in detail with reference to the drawings. The features mentioned in the claims and in the description may each be essential to the invention individually or in any desired combination. Where the term “can” or “may” is used in this application, this means both a technical possibility and the actual technical implementation.

Exemplary embodiments are explained in the following text on the basis of the accompanying drawings, in which, in a schematic illustration:

### BRIEF DESCRIPTION OF THE DRAWINGS

FIG. 1 shows individual method steps of an example of a method, and

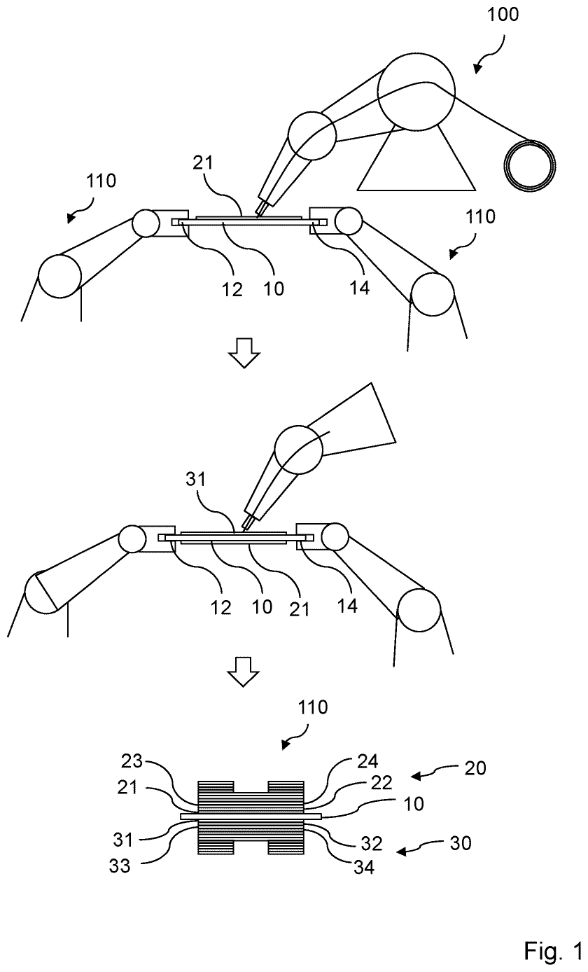

FIGS. 2 and 3 show a perspective illustration of an example of a structural component in two views.

### DETAILED DESCRIPTION OF THE DRAWINGS

In an example of a method for producing a structural component 1, a central workpiece 10 having two finish-machined regions 12, 14 is provided. These finish-machined regions 12, 14 are used for two handling robots 110 to grip and position the central workpiece 10 in a manufacturing device 100 for wire-based build-up welding. Then, a first and second component portion 20, 30, respectively, are created on the two sides of the central workpiece, with the result that the central workpiece 10 is geometrically extended. The first component portion 20 and the second component portion 30 are created by means of wire-based build-up welding, to which end a wire-form workpiece is melted and deposited in a predefined path. The latter is materially bonded to the central workpiece 10, or the material layer located therebeneath.

The first component portion 20 and the second component portion 30 thus consist of a plurality of superposed material layers 21, 22, 23, . . . , 31, 32, 33, . . . , which are formed sequentially. To reduce the thermal distortion in the component, it is particularly preferred for a material layer of the first component portion 20 and a material layer of the second component portion 30 to be produced alternately in the method. To this end, the central workpiece 10 can be rotated through 180°, for example, after the formation of a material layer. Thus, the first component portion 20 and the second component portion 30 grow uniformly in terms of height. This is maintained preferably at least for the first material layers, for example, the first 5 or first 10 layers. Subsequently, the component portions are completed.

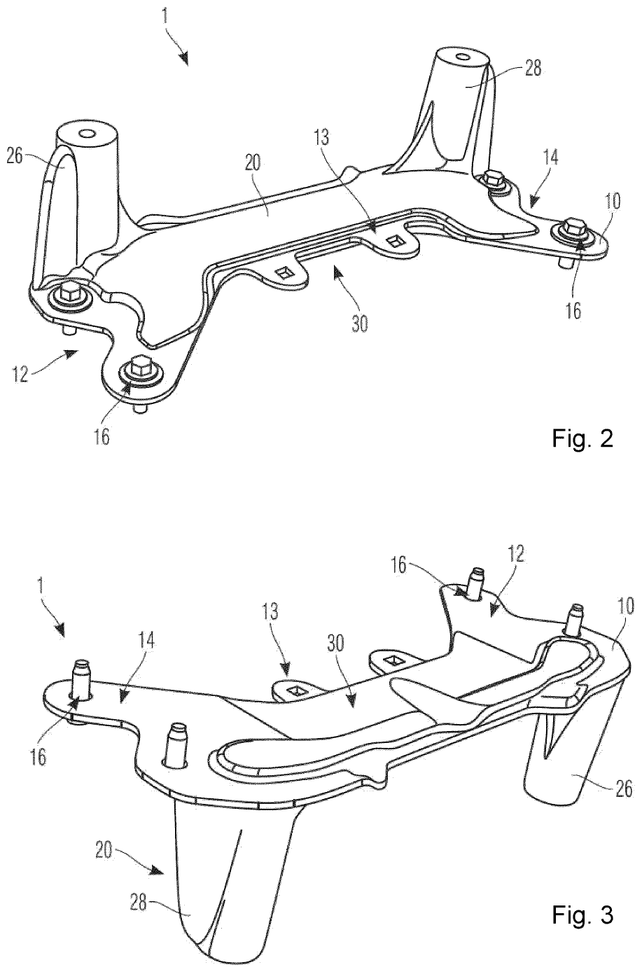

FIGS. 2 and 3 show an example of a structural component 1 which has been produced using the method. The structural component 1 shown forms a tunnel reinforcement for a motor vehicle. As the central workpiece 10, use was made of a plate-like sheet-metal body which already has a plurality of finish-machined regions 12, 13, 14 in its peripheral region. In these regions, fastening points 16 in the form of through-holes have been formed, these being used for the subsequent screw-connection of the structural component 1 to the vehicle. For example, screws are already illustrated in the through-holes. On a first side of the central workpiece 10, a first component portion 20 is formed having two hollow bodies 26, 28 which extend perpendicularly into space from the central workpiece 10. Formed on the opposite side, in a central region, is a second component portion 20, which forms a reinforcing and stiffening structure.

### LIST OF REFERENCE SIGNS

1 Structural component
10 Central workpiece
12, 14 Finish-machined regions
16 Fastening points
20 First component portion
21, 22, 23, . . . Material layers
26, 28 Hollow bodies
30 Second component portion
31, 32, 33, . . . Material layers
100 Manufacturing device for wire-based build-up welding
110 Handling robots

1.-9. (canceled)

10. A method for producing a structural component for a motor vehicle, the method comprising:
providing a central workpiece having at least one finish-machined region;
positioning the central workpiece using the finish-machined region in a predetermined position in a manufacturing device for wire-based build-up welding;
geometrically extending the central workpiece with a first component portion on a first side of the central workpiece; and
geometrically extending the central workpiece with a second component portion on a second side of the central workpiece that is on an opposite side from the first side,
wherein geometric extension of the central workpiece is effected by application of material in layers via wire-based build-up welding.

11. The method according to claim 10, wherein the central workpiece has its final geometric intended shape at a start of the method.

12. The method according to claim 10, wherein the central workpiece has, at a start of the method, an initial shape that differs from its final geometric intended shape and has been determined such that the central workpiece is transferred into its final geometric intended shape by thermal distortion that arises in the method.

13. The method according to claim 10, wherein a layer of the first component portion and a layer of the second component portion are created alternately.

14. The method according to claim 11, wherein a layer of the first component portion and a layer of the second component portion are created alternately.

15. The method according to claim 12, wherein a layer of the first component portion and a layer of the second component portion are created alternately.

16. The method according to claim 10, wherein, to position the central workpiece at a start of the method, fastening points are used that have been formed in the finish-machined region and are required on the structural component when finished.

17. The method according to claim 11, wherein, to position the central workpiece at a start of the method, fastening points are used that have been formed in the finish-machined region and are required on the structural component when finished.

18. The method according to claim 12, wherein, to position the central workpiece at a start of the method, fastening points are used that have been formed in the finish-machined region and are required on the structural component when finished.

19. The method according to claim 13, wherein, to position the central workpiece at a start of the method, fastening points are used that have been formed in the finish-machined region and are required on the structural component when finished.

20. The method according to claim 10, wherein the central workpiece is made of sheet metal.

21. The method according to claim 11, wherein the central workpiece is made of sheet metal.

22. The method according to claim 12, wherein the central workpiece is made of sheet metal.

23. The method according to claim 10, wherein the central workpiece comprises a plate-like body.

24. The method according to claim 11, wherein the central workpiece comprises a plate-like body.

25. The method according to claim 12, wherein the central workpiece comprises a plate-like body.

26. The method according to claim 10, wherein at least one of the first component and the second component portion includes a hollow body.

27. The method according to claim 11, wherein at least one of the first component and the second component portion includes a hollow body.

28. The method according to claim 12, wherein at least one of the first component and the second component portion includes a hollow body.

29. A structural component produced by a method according to claim 10, the structural component comprising:
a central workpiece including at least one exposed region;
a first component portion joined to the central workpiece on a first side of the central workpiece; and
a second component portion joined to the central workpiece on a second side of the central workpiece on an opposite side from the first side;
wherein the first and second component portions have a structure resulting from wire-based build-up welding.
